(19) United States
(12) Patent Application Publication
(10) Pub. No.: US 2011/0246014 A1
(43) Pub. Date: Oct. 6, 2011

(54) CONDUCTIVE POWER REFUELING

(75) Inventor: Eckhard Sauper, Klagenfurt (AT)

(73) Assignee: SAUPER UMWELTDATENTECHNIK GESELLSCHAFT M.B.H., Klagenfurt am Worthersee (AT)

(21) Appl. No.: 13/139,434

(22) PCT Filed: Dec. 14, 2009
(86) PCT No.: PCT/AT2009/000488

§ 371 Date: Jun. 13, 2011

(30) Foreign Application Priority Data
Dec. 12, 2008 (AT) A 1935/2008
Jan. 20, 2009 (AT) A 84/2009
Jan. 27, 2009 (AT) A 135/2009

(51) Int. Cl. G06F 17/00; H02J 7/00; H01R 13/70; H01R 13/44; H01R 3/00; H01R 13/62; G05F 3/00

(52) U.S. Cl. 701/22; 320/109; 439/620.21; 439/137; 439/488; 439/345; 323/304

(57) ABSTRACT

A high-current transmission device for conductive charging of the batteries of electric vehicles has a socket with an integrated electromechanical switching function and at least one contactor. The contactor is configured without terminal contacts on the side facing the plug-and-socket connection and is part of the socket. The terminal contacts are located on a removable plug that is provided with plug contacts. A modular charging station system for conductive charging of the batteries of electric vehicles has a base unit, a master module, and a user module, with the base unit being configured without electronics and having at least one clamping device for the power feed and compartments for accommodating the master module and the user module. The master module and the user module form a high-current transmission device, with the master module having a socket and the user module having a plug that corresponds to the socket of the master module.

The invention relates to a high-current plug-and-socket connection system for charging the batteries of electric vehicles.

Furthermore, the invention relates to a modular charging station system for charging the batteries of electric vehicles.

Moreover, the invention relates to a method for handling the charging of batteries of electric vehicles.

In coming decades in the domain of energy supply, Europe will have to manage many challenges. One key component is the replacement of fossil fuels in the area of mobility (transportation) by biofuels, hydrogen or electrical energy, especially electric vehicles being promoted in the future. Electric vehicles are generally charged via the public power grid. According to one study, 2.3 charging stations are needed per electric vehicle—one at home, one at work, and 0.3 at public locations. 70% of all vehicle owners in cities cannot charge an electric vehicle at home. Therefore, a blanket infrastructure of public charging stations must be set up.

In principle, there are four possibilities for charging the batteries of electric vehicles:
The batteries or battery packs to be charged are optionally removed by way of a robot and re-installed after charging (battery charging).
Current is transmitted without contact via coils and high-frequency currents (therefore inductively).
There are high-current cables (therefore conductive) with a corresponding plug for the electric vehicle at the charging station.
At the charging station, there are high-current plugs to which a carried charging cable can be connected.

In all four possibilities, the charging stations for charging the batteries of electric vehicles have a power transmission device. The disadvantage is that in this respect, there are no standardized battery charging stations or charging station systems since neither charging times (e.g., between 30 minutes and 8 hours) nor the energy capacity of the batteries (for example, a range up to 300 km and more) nor battery systems (for example, lithium ions) can be defined.

Modern charging stations must satisfy the following criteria:
Self-service
Low expenditure of effort in the establishment of the power connection
High plug cycles or battery-charging cycles
Continuous charging power setting (dynamic distribution of the grid capacities)
Manipulation-proof (power theft)
Sophisticated protective electronics to prevent electrical accidents
Disconnection, accurate metering and account settlement (with prepaid function)
Free choice of power provider
High protection against vandalism
Interlocking of the plug-and-socket connection from the station to the vehicle to prevent unauthorized removal of the plug or cable,
Small housing, versatile installation possibility (columns, walls, etc.)
Prompt and easy maintenance and fault correction
Protection against weather conditions (heat, cold, moisture, . . . )
Economical
Transnational
Management of voltages up to 400 VAC and currents up to 63 A
Standard EN61851-1 “Conductive Charging Systems for Electric Vehicles” must be observed.

Currently available charging stations are made from standard components, such as power meters, fault current circuit breakers, automatic circuit breakers, and the corresponding floor-mounted housings. They correspond only in part to modern criteria, are very costly, technically complicated and expensive to maintain.

The object of the invention is to enable conductive charging of the batteries of electric vehicles for self-service operation at a charging station in which the indicated disadvantages are avoided and the indicated, required criteria are met.

This object is achieved according to the invention with a high-current plug-and-socket connection system that has the features of claim 1.

Furthermore, this object is achieved according to the invention with a modular charging station system that has the features of claim 14.

Moreover, this object is achieved with a method for handling the charging of batteries of electric vehicles that has the features of claim 35.

Preferred and advantageous embodiments of the invention are the subject matter of the dependent claims.

With regard to the high-current plug-and-socket connection system, this object is achieved in that a pluggable power transmission device is made available in which a contactor is reconfigured such that it is part of the socket and also can be configured as a housing installation unit. Normally, a contactor has terminal contacts on two opposite sides. In the high-current plug-and-socket connection system according to the invention, the contactor has one side assigned to the plug-and-socket connection (=switched side) and one side facing away from the plug-and-socket connection. According to the invention, it is provided that the contactor is configured without terminal contacts on the switched side and is part of the socket of the high-current transmission device and that the terminal contacts are located on a removable plug that is provided with plug contacts. The difference from a known contactor is that the terminal contacts that are generally provided with screws on the contactor itself are absent on the switched side, and they are now a component of a removable plug with the corresponding tabs. The high-current transmission device according to the invention is thus especially well suited to high plug cycles, the expenditure of force for establishing and breaking the connection between the current source and the current consumer (plug-and-socket connection) being very low.

In one especially preferred embodiment of the high-current transmission device according to the invention, it is provided that the plug-and-socket connection after electrical triggering of a coil conductively connects the plug contacts to socket contacts via switching contacts with a high expenditure of force; this prevents breaking of the connection in the switched state, optionally in conjunction with an additional interlocking system, and it enables it again in the unswitched state without the expenditure of force.

In contrast, conventional industrial plugs for high-current intensities (e.g., 63 A at 400 V) require the expenditure of a force of several kiloponds (kp) and can in most cases only be operated with the corresponding levers. Moreover, the plug cycles for conventional industrial plugs are very small, and it must be ensured that the high-current transmission device is not under voltage during the plug connection and separation.

The contactor can be a 1-pin, 2-pin or multiple-pin contactor within the framework of the invention.

The socket can be part of a first adapter (master module) that is provided fixed in a charging station, and conversely the plug can be part of a second mobile adapter (user module). With the power transmission device according to the invention, it is thus possible to implement a modular charging station system that achieves the underlying object of the invention.

This object is achieved, moreover, by an intelligent, inherently reliable and easily installed and operated modular charging station system for charging the batteries of electric vehicles. The modular charging station system has a base unit (docking station), a master module, and a user module, the base unit being made free of electronics and having at least one clamp device or plug-in device for current feed and compartments for holding the master module and the user module. The base unit is versatile in mounting and vandalism-proof. The master module and the mobile user module can be easily replaced; this guarantees prompt and easy fault correction.

The base unit can be a stationary housing at a charging station. The master module is a first adapter that is located in the base unit. The user module is a second adapter that can be mounted on or in the base unit and that is connected to the master module via a plug-and-socket connection for charging batteries. The master module for this purpose has a socket into which a corresponding plug of the user module can be plugged. Master module and user module thus form a high-current plug-and-socket connection system.

The power provider or the operator of the charging station is responsible for the start-up and initialization of the charging station. The charging station, if the base unit is already installed, can be started up by means of the master module. The master module is placed in the master compartment and locked safe from theft by means of a key interlock or screw interlock. The master module establishes the address of the column via coding, determines the purpose of the charging column (private, public), and has a disconnection relay for disconnection of the charging voltage. Optionally, there can be calibration electronics.

The vehicle owner has the intelligent user module with protective, measurement and evaluation electronics and with communications electronics for the data connection to a higher-level server (account settlement, statistics). The vehicle owner will generally buy or lease the user module. At the same time, he acquires a SIM card and a log-in for a corresponding Internet platform for setting up an account (account settlement). With the system according to the invention, it is now legally and technically possible to charge batteries at network accesses (=charging station) independently of the power provider.

The user module is made similarly to an intelligent plug adapter and on one side has a socket (220 V or 400 V) for the charging cable of the electric vehicle and on the other side a plug for the base unit. The user module can also be connected directly to the charging cable. The charging process, i.e., the battery charging, proceeds with plugging the user module into the charging cable. The internal electronics monitors a possible ground fault or creepage fault of a current-carrying conductor relative to ground and displays this via an LED display. This function makes operation very safe and avoids power accidents. The user module is inserted into the base unit via a corresponding guide system, as a result of which a protective flap to the socket opens and the user module is then connected. The user module is locked against theft by means of a key or transponder interlocking system. The flap prevents the charging cable from being withdrawn during the charging process.

As soon as the electronic unit recognizes that charging can be initiated, the user module automatically establishes a data connection to a server, checks a possible balance and begins with release of the charging voltage. After completed charging, the vehicle owner is notified via SMS and all data are transmitted to the Internet platform. At the end of the charging process, the driver pulls the user module that remains in his custody out of the intended compartment of the base unit.

The charging station system according to the invention satisfies all of the initially mentioned criteria and is best suited to reliably and easily establishing the infrastructure for charging electric vehicles. Advantages of the system can be summarized as follows:

The base unit (docking station) is standardized and can be quickly premounted on walls or poles. For example, a streetlight can also be used as a charging station. It is small in dimensions, vandal-proof, and without electronics. Power cannot be imported without a master module and user module. Various designs are possible. The provider can use premounted base units by his installing his master modules and providing the vehicle owner with user modules with SIM cards.

The master module can be equipped differently. Thus, the base unit can be outfitted both as a private and as a public service station. A public service station can be a reference meter. The master module with which the service station is initialized can be labeled with the logos of providers.

The user module is distributed by a power provider or service station owner with the SIM card (as in a cell phone). The customer receives a log-in to an Internet platform. There, he can open an account. After plugging in the user module and locking, customer verification with charging location takes place automatically. The charging process begins. After the charging process is completed, the data are relayed to the account holder via SMS. All the electronics are always carried with the user module, with which all problems with respect to heat, cold, moisture and vandalism are avoided. The costs that are calculated relative to one electric vehicle are low.

A safe charging process is ensured (power accident) by the electronic ground fault monitoring directly after plugging the charging cable into the user module.

Power theft is impossible. Since there can be standard meters unrecognized in the master modules, when the data in the user module deviate, the account is immediately blocked. The data are also filed in a permanent storage device and rechecked for each communication. Exact energy accounting can be carried out over the Internet. A simple prepaid method controlled via a GPRS communications unit is possible. Within the framework of the invention, other communications units, e.g., GSM communications units, can also be used.

The system can be operated with the power transmission device according to the invention and can be used for any country.

Furthermore, the object is achieved by a method for charging the batteries of electric vehicles in which a first communications unit of a central computer is connected via a first data transmission means to at least one cell phone and to at least one adapter for a charging station and in which battery charging is monitored and accounts are settled via the communications unit of the central computer. Preferably, the first communications unit of the central computer is the Internet.

In one preferred embodiment, the adapter of the charging station is connected to a second communications unit, which is connected via a second data transmission means to at least one charging station means, and to a third communications unit, which is connected via a third data transmission means to at least one electric vehicle. Furthermore, the adapter for the charging station can import data from the charging station or the electric vehicle via the second and/or third communications unit and can output commands to the charging station or to the electric vehicle. In addition, it can be provided that the charging station means is connected to a fourth communications unit, which is connected to at least one additional charging station means via a fourth data transmission means. In particular, it can be provided that the adapter imports data about the charging station via the fourth communications unit and/or controls it (disconnections, rate display, etc.).

Within the framework of the invention, it is preferred if after connecting an electric vehicle to the charging station in a first step, a connection to the central computer is established via the first communications unit, in a second step the data are checked, and if the check is positive, in another step battery charging is enabled. After enabling battery charging in a first step, data about mechanical connections of charging station means (e.g., diverse interlocks of plug-and-socket connections) and/or about the current flow (e.g., temperatures of plug-and-socket connections, ground fault currents and leakage currents) and/or about a power measurement means on the adapter are checked and monitored by the central computer and/or the adapter via protective and monitoring electronics in the adapter, the charging voltage for charging the electric vehicle being enabled in a further step for a positive check.

During charging of the electric vehicle, data about mechanical connections of the charging station means and/or about the current flow and/or about a power measurement means on the adapter can be checked and monitored preferably by the central computer and/or the adapter. Alternatively or additionally, data about battery charging can be sent to the cell phone during charging of the electric vehicle.

Within the framework of the invention, it can be provided that current and/or historical data about battery charging are graphically displayed and that the data are stored in the central computer and/or in the adapter, in a data interruption the data that have not been transmitted to the central computer being buffered in the adapter and in the next charging process being transmitted to the central computer. During charging of the electric vehicle, the vehicle owner or other individual can monitor processes in the electric vehicle during the charging process, and switching processes can be carried out, especially for manual or programmed remote control.

Within the framework of this invention, battery charging is defined as automatic charging (filling) of an electric vehicle with current and account settlement of the current withdrawal after safe, inherently reliable connection/disconnection of an electric vehicle to/from a charging station. Within the framework of this invention, the vehicle holder is defined as an individual who drives an electric vehicle to a charging station for purposes of charging the batteries and operates this charging station according to instructions. Within the framework of this invention, a grid operator is defined as the organization that is responsible for the supply region (grid) of a certain charging station. Within the framework of this invention, a charging station organizer is defined as the organization that is responsible for the building and operation of a certain charging station. The power provider within the framework of this invention is defined as the organization that is responsible for the power supply of a certain charging station.

The adapter for the purposes of this invention is made either as a stationary or as a mobile means that can be mounted between a charging cable or on a charging cable or else on the electric vehicle. The adapter is preferably carried by the vehicle holder (user module) and is used only for charging the batteries at the charging station. Specifically, the adapter can be connected to a communications unit of the central computer, e.g., via a telecommunications network, a cable TV network or a computer network such that it is possible to carry out all processes including account settlement of battery charging. Generally, the adapter has electronics for detection of fault states (protective electronics), electronics for measuring the charging energy (measurement electronics), electronics for generating a pilot signal according to Standard EN61851-1 or for communications with the vehicle electronics and in the case of a mobile means integrates an electromechanical device for preventing unauthorized removal of the adapter. The adapter can be equipped with displays and controls and can also communicate on site with the charging station means.

A charging station means within the framework of this invention is defined as a unit that establishes the address of the charging station and carries out disconnection of the charging voltage for battery charging via a switch contactor. The charging station means can also be equipped with a rate display. Several charging station means can exchange data among one another via a communications unit.

A charging station organizer that acquires a charging station organizer access to a charging station portal on the central computer installs, in the supply region of the grid operator who acquires a grid operator access to a charging station portal, a charging station at a certain location with the assigned number and the corresponding location coordinates. The charging station organizer or the vehicle holder selects a power supplier that acquires a power supplier access to the charging station portal on the central computer, for this charging station or this adapter. All data are stored accordingly in the central computer in the master database.

A charging station organizer or a vehicle holder who is also comprehensively registered in the central computer in the master database and acquires vehicle holder access to a charging station portal is the owner or lessee of an intelligent adapter that authorizes him to charge batteries. After autonomous connection of an electric vehicle by the vehicle owner to a charging station, consisting of the charging station means and adapter, as the first step a connection to the central computer is established automatically via the first communications unit and the data are checked as the second step, and in a positive check of the data, as the third step, the process of battery charging is started. As the fourth step, diverse interlocks, temperatures of the connector on the adapter, ground fault currents and leakage currents and the power measurement means on the adapter are monitored and checked by the adapter itself or by the central computer. For positive checks, as the fifth step, the charging voltage is enabled by a safety disconnection contactor on the charging station installation for charging the electric vehicle.

During the charging process, diverse interlocks, temperatures of the connectors, ground fault currents and leakage currents and the power measurement means on the adapter are continuously monitored by the adapter itself and/or by the central computer. Since charging stations are generally operated unsupervised and in the future charging currents up to 63 A and charging voltages up to 440 VAC must be managed, especially also the contact resistances of the connectors—by monitoring the housing temperatures, by monitoring transient current peaks and the detection of ground fault currents and creepage currents—are very important. Recorded faults lead to immediate disconnection.

The vehicle owner is continuously notified via cell phone about the battery-charging process. The vehicle holder—as well as the grid operator, the charging station organizer and the power supplier—also has the option to monitor the ongoing and past battery recharging processes at any time via the charging station portal and via their secured accesses. Account settlement takes place via the central computer.

The adapter also has a communications unit that can be connected via a wired or wireless (radio) data transmission means to at least one electric vehicle via which the vehicle holder (or anyone else) can monitor processes in the electric vehicle and can carry out switching processes, e.g., manual or programmed remote control of the heating system.

Each grid operator acquires grid operator access to the portal on the central computer via which the charging stations that are located in its supply region can be managed. The grid operator generally does not acquire any information about those individuals who are using the station.

The charging station organizer acquires charging station organizer access to the portal via which those stations that are in his region can be managed. If online data transmission is used, displays of the charging processes in real time (3 second values) can be displayed and also, e.g., in supply bottlenecks, charging processes can be briefly interrupted. The charging station organizer then acquires only information when this is expressly noted at the charging station. For this purpose, there are, e.g., more favorable rates.

The power provider or charging station organizer generally transfers the adapter with the SIM card and network access to the vehicle holder. Each power provider acquires power provider access to the portal via which those customers who would like to draw power there can be managed.

The vehicle holder acquires vehicle holder access to the portal to the charging station platform where all activities are recorded and also account settlement (prepaid, via SIM card . . . ) is carried out. The vehicle owner can exactly ascertain when he has drawn how much electrical energy (graphic display) and can communicate via certain WEB applications or via cell phone with the electric vehicle (e.g., turn on the heating system).

Other details, features and advantages of the invention will become apparent from the following description with reference to the attached drawings, in which preferred embodiments are shown.

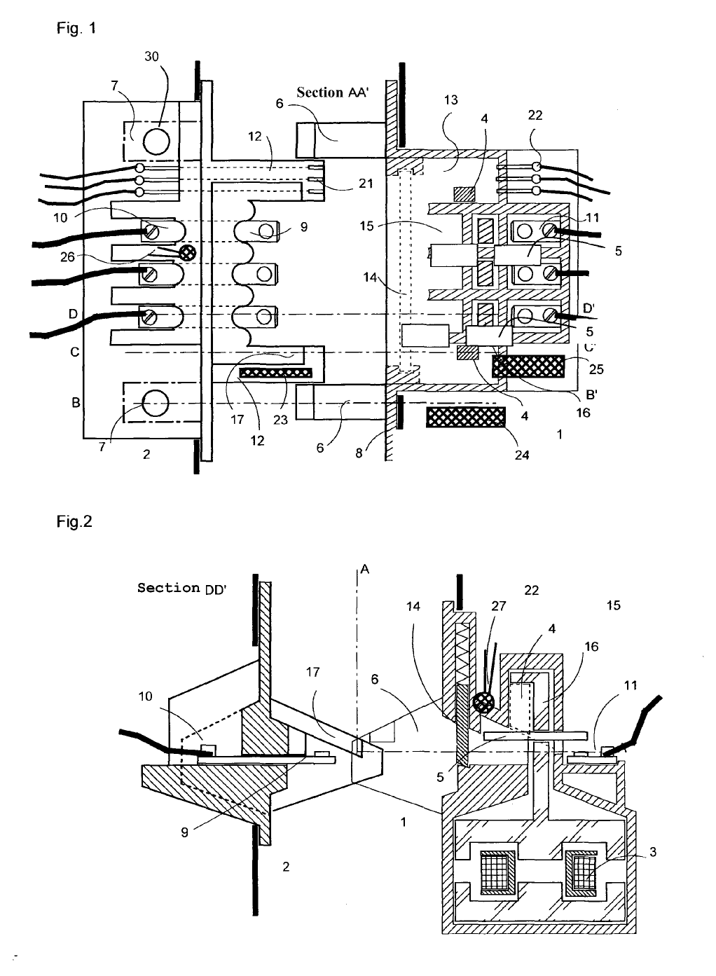

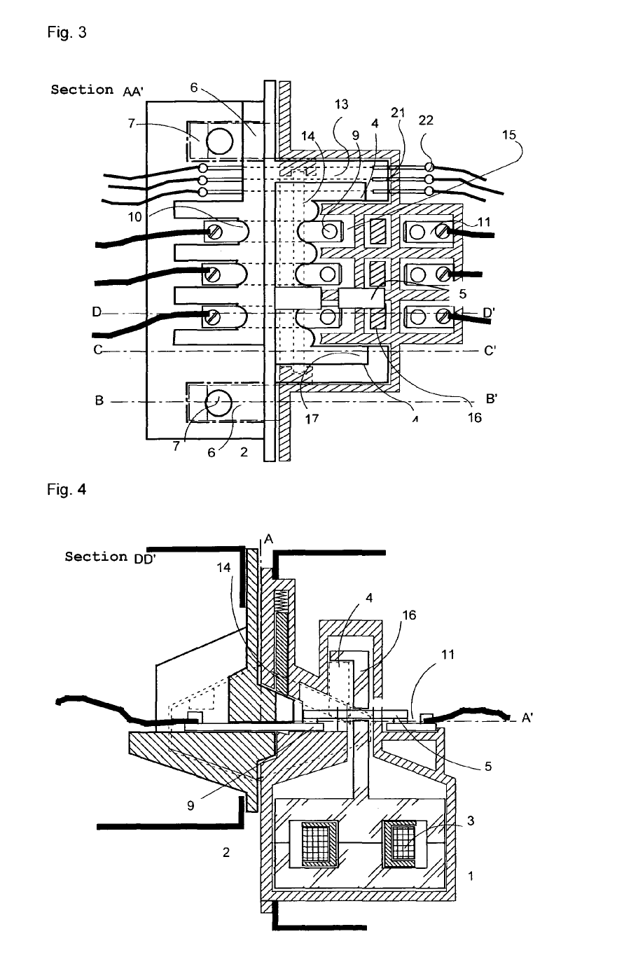

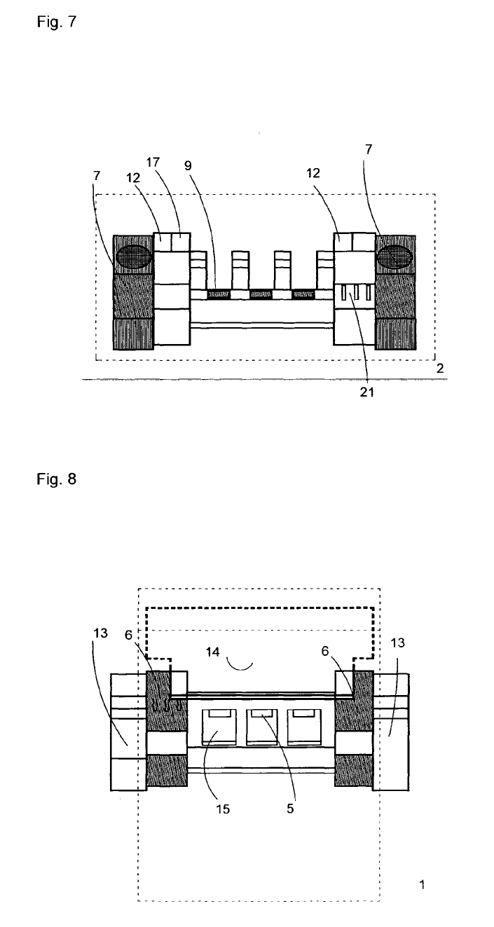

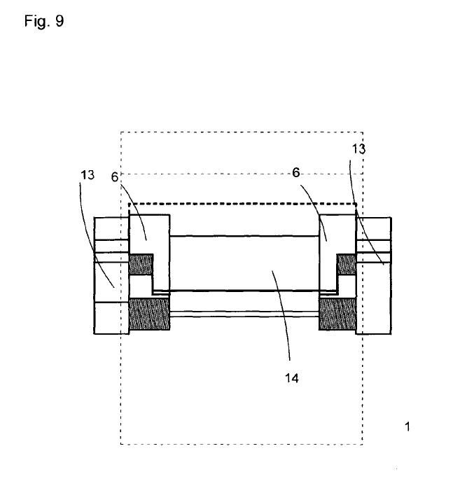

FIGS. 1 to 9 show embodiments of a high-current transmission device according to the invention, and

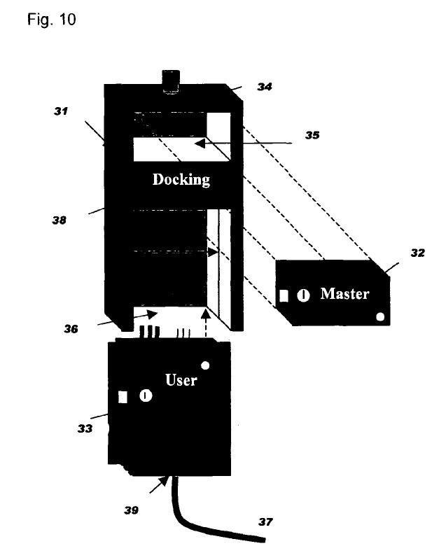

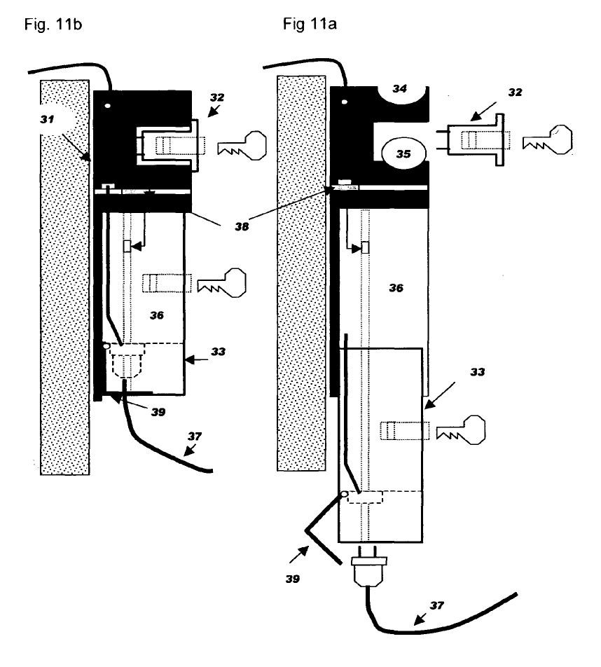

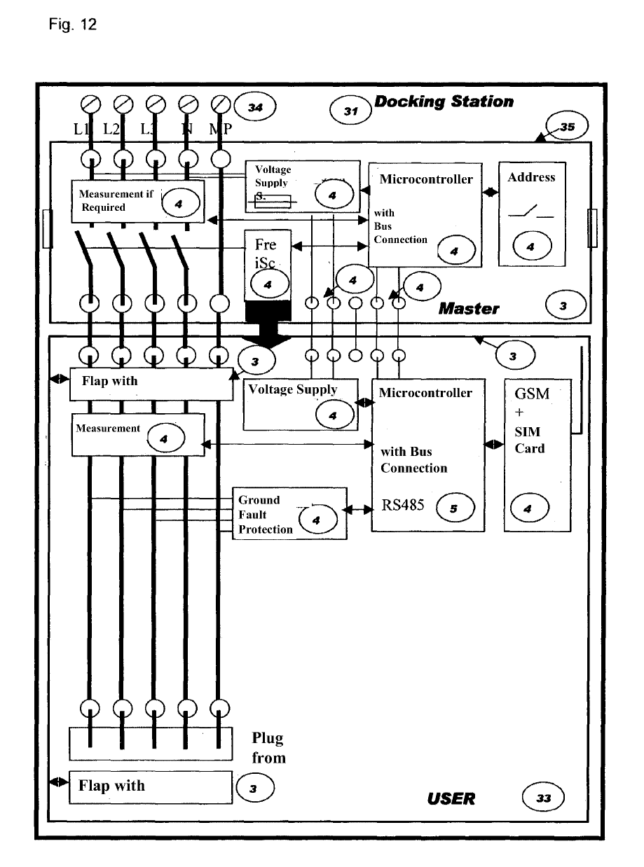

FIGS. 10 to 12 show embodiments of a charging station system according to the invention.

FIGS. 1 to 9 show embodiments of high-current transmission devices according to the invention in which a contactor is configured such that it is part of the socket 1 and also can be configured as a housing installation device. On the contactor, the terminal contacts 11 that are generally provided with screws are absent. They are located on a removable plug 2 that is provided with plug contacts. After electrical triggering of a coil 3, the plug-and-socket connection 1, 2 connects the plug contacts 9 with socket contacts via switching contacts 5 with a high expenditure of energy.

The plug 2 has cone-shaped guide projections 12 and corresponding socket-side recesses 13. Alternatively or in addition, it can be provided that the socket has cone-shaped guide projections 6 and corresponding plug-side recesses 7 and that the plug-side guide projection 12—when the plug 2 is inserted into the socket 1—moves a protective flap 14 such that it clears socket openings 15. Thus, the insertion of a plug 2 into the socket 1 is possible with precision and without exertion, with the penetration of dirt and moisture being prevented. Moreover, the protective flap 14 offers protection from electric shock, with which the safety for the user is increased.

The high-current transmission device according to the invention can be used wherever high-current connections between a mobile device (plug) and to a power supply source (socket) must very often be established and broken again with less expenditure of force. The connection is only energized (connection of the electrical voltage) when it is ensured that it is a registered user; this can be ascertained by coding of the plug 2 and when no errors are recorded in the mobile device, which can take place by impedance measurement or the like.

One important effect of the high-current transmission device according to the invention is that only an authorized individual can break the connection again between the power source and the current consumer only under certain conditions (de-energized).

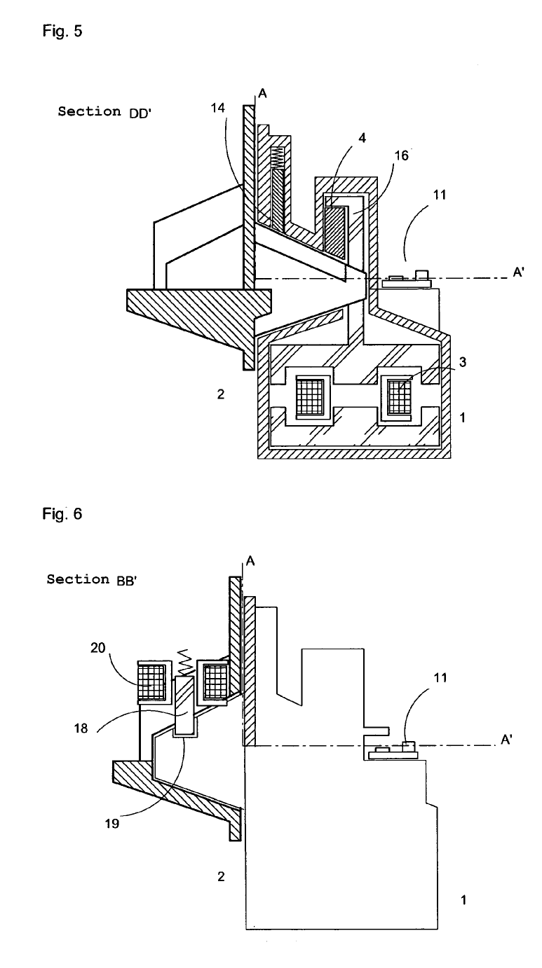

For this purpose, the high-current transmission device is interlocked on the socket side and/or plug side, preferably on both sides. For socket-side interlocking (FIG. 5), at least one (especially two) lock(s) 4 that is/are directly coupled to the contactor drive 16 can be locked into a corresponding recess 17 of the plug-side guide projections 12 under the force of the magnetic field of the contactor coil 3. The corresponding configuration of the guide projections 12 and the lock 4 ensures that the contactor can only close when the plug 2 has been correctly inserted and that the smallest unintended tilted positions are equalized (straightened) when the contactor is closed. The high-current transmission device uses the force of the magnetic field of the contactor coil 3, on the one hand, for the socket-side interlocking of the plug-and-socket connection 1, 2 and, on the other hand, for increasing the contact forces between the socket contacts 9 and the switching contacts 5; this is especially important when high-current intensities are applied. The socket-side interlock system reliably prevents live removal of the plug 2.

A plug-side interlocking system (FIG. 6) can be provided in the region of the plug-side recess 7 into which a guide projection 6 of the socket 1 can be inserted. The plug-side interlocking system consists of at least one lock 18 that is located on the plug 2 and a corresponding recess 19, and in addition, there can be an unlocking system 20. The interlocking system can be made on one side or both sides and, on the one hand, ensures the correct seat of the plug 2 before the socket-side interlocking system is in force, and on the other hand, prevents the unauthorized removal or falling out of the plug 2 with the socket 1 unlocked. The plug-side interlocking system is generally electrically triggered, but it can also have a mechanical transmission to the lock 18 so that it can also be operated with a key.

Within the framework of the invention, the plug-side and/or the socket-side interlock can be assigned a mechanical or electrical unlocking mechanism.

Preferably in the plug 2 and/or in the socket 1, there is thermal monitoring that can comprise a temperature-dependent resistor or semiconductor 26 and evaluation electronics. For example, in the plug, there is a temperature-dependent semiconductor (e.g., PTC, PT100). By way of evaluation electronics integrated in the socket 1 or in the plug 2, the temperatures are evaluated accordingly, and if a given value is exceeded, power transmission is turned off. Advantageously, thermal monitoring takes place in the socket part 27 so that it is ensured that as a result of fouling or as a result of other circumstances, thermal destruction of the plug-and-socket connection 1, 2 by premature shutoff cannot occur. Another protective measure is the measurement of transient current peaks via ferrite coils on the current-carrying conductor in order to be able to ascertain possible loss of contact.

The system according to the invention is made 3-pin in the figures, but it can be made with several main contacts 9 (e.g., 1-pin, 3-pin, 4-pin, ground conductor) and also with auxiliary contacts 21. This can be achieved in that (at least) one plug-side guide projection 12 can have the required contacts 21 that can be connected to the sliding or plug-in contacts 22 that are mounted in the socket-side recess 13. The contacts can be produced both on the plug side and also on the socket side via guide projections and the corresponding recesses. These auxiliary contacts can be used for auxiliary voltage supply and/or for bus systems and/or temperature monitoring and/or for identification of the plug 2.

In one embodiment of the invention, it is provided for identification of the plug 2 that at least one guide projection 12 of the plug 2 or the plug 2 has a transponder chip 23 that can be evaluated via a receiver 24 that is mounted in the socket 1.

The power transmission system according to the invention can also be equipped with a reset system 25, e.g., for resetting a triggered, automatic contactor. The reset system 25 is placed in a socket-side recess 13 and can be moved by re-insertion of the plug 2 by means of the socket-side guide projection 12.

FIGS. 10 to 12 show a charging station system for charging the batteries of electric vehicles. The charging station system consists essentially of three parts, a base unit 31, a master module 32, and a user module 33. The base unit 31 is configured without electronics and has a clamping device 34 (for L1, L2, L3, N, MP (220V/400V, 20 A)) for power feed and compartments 35, 36 for holding the master module 32 and the user module 33. In the compartments 35, 36, there are corresponding sockets for the charging current and electronics.

The base unit 31 has a flap 38 for clearing and closing plug-and-socket connections for the user module 33. The flap 38 can only be operated by proper insertion of the user module 33 and thus by corresponding release or locking. The master module 32, which can have different functions, is installed by the power provider or charging station operator, with which the charging station is parameterized. The master module 32 has a location identification 45 that can be set by microswitch, flash memory, transponder, etc., or other common codings and that—similar to an IP address—is a unique identification. Moreover, the master module 32 has an auxiliary voltage supply 43 for disconnection electronics, a system bus, a supply of a slave module or the like or for electronic displays. In public service stations, in the master module 32, there is a switching relay 44, especially a 2- or 4-pole switching relay 44, for disconnecting the charging voltage and for shutoff in a ground fault or overcurrent. A corresponding interlocking mechanism prevents the user module 33 from being pulled out with the relay 44 switched. Furthermore, on the master module 32, there is a power measurement and energy metering unit 46 for additional monitoring of a measurement means that is generally located on the user module 33. The master module 32 supplies the user module 33 with current via two voltage supply lines 47; the master module 32 (microcontroller 50 with bus connection) and the user module 33 (microcontroller 51 with bus connection) communicate via two system bus lines 48.

In the position of use, on the bottom of the user module 33, there is a flap 39 for releasing a country-specific plug. The flap 39, after insertion of the user module 33 into the base unit 31, prevents unauthorized removal of the charging cable 37 by mechanical interlocking. The user module 33 has metering electronics 40 (for measurement of the amount to be settled, e.g., the number of power units) and a communications unit 42 and has an energy storage 49 (voltage supply with battery) that after inserting the user module 33 into the base unit 31 is charged via the master module 32. The communications unit 42 is a GPRS or GSM unit with a SIM card compartment for communications via modem connection or SMS with a server center for purposes of customer recognition, disconnection and account settlement. After inserting the user module 33 and corresponding obstruction, an identification SMS is sent. It is evaluated and with the corresponding prepaid (balance) coverage, the current is enabled. At the end of battery charging, the vehicle owner receives an SMS with data (kWh, amount to be paid, charging time, etc.). In a brief interruption, immediate shutoff occurs. All data are stored in the communications unit 42. Furthermore, the user module 33 has a 2-phase or 3-phase power measurement and energy metering means whose data are sent to a central server via the communications unit 42.

On the user module 33, there is a protective electronic device 41 for ground fault monitoring that is active before insertion of the user module 33 into the base unit 31 and displays errors via an LED display. The charging voltage is not enabled if there is an error.

In summary, one embodiment of the invention can be described as follows:

A high-current transmission device for conductive charging of the batteries of electric vehicles has a socket 1 with an integrated electromechanical switching function and at least one contactor. The contactor is configured without terminal contacts on the side facing the plug-and-socket connection and is part of the socket 1. The terminal contacts 11 are located on a removable plug 2 that is provided with plug contacts 9.

A modular charging station system for conductive charging of the batteries of electric vehicles has a base unit 31, a master module 32 and a user module 33, with the base unit 31 being configured without electronics and having at least one clamping device 34 for the power feed and compartments for accommodating the master module 32 and the user module 33. The master module 32 and the user module 33 form a high-current transmission device, with the master module 32 having a socket and the user module 33 having a plug that corresponds to the socket of the master module 32. The master module 32 remains in the base unit 31; conversely, the mobile user module 33 is in the possession of the vehicle owner before and after battery charging. With the user module 33 that has a metering unit 40, charging can take place independently of a certain power provided.

In a method for handling conductive battery charging of electric vehicles, a first communications unit of a central computer is connected to at least one cell phone and to at least one adapter of a charging station via a first data transmission means. Battery charging is monitored, and accounts are settled via the communications unit of the central computer.

1. High-current plug-and-socket connection system for charging the batteries of electric vehicles, with a socket (1), with an integrated electromechanical switching function, and with at least one contactor, characterized in that the contactor is configured without terminal contacts on the switched side and is part of the socket (1) of the high-current transmission device and in that the terminal contacts (11) are located on a removable plug (2) that is provided with plug contacts (9).

2. High-current plug-and-socket connection system according to claim 1, wherein after electrical triggering of a coil (3), the plug contacts (9) are conductively connected to socket contacts via switching contacts (5).

3. High-current plug-and-socket connection system according to claim 1, wherein the plug (2) has cone-shaped guide projections (12) and corresponding socket-side recesses (13).

4. High-current plug-and-socket connection system according to claim 1, wherein when the plug (2) is inserted into the socket (1), the guide projection (12) of the plug (2) moves a protective flap (14) such that it clears the socket openings (15).

5. High-current plug-and-socket connection system according to claim 3, wherein the socket (1) has cone-shaped guide projections (6) and corresponding plug-side recesses (7).

6. High-current plug-and-socket connection system according to claim 5, wherein it is interlocked on the plug side and wherein the plug-side interlock has at least one lock (18) that is located on the plug (2) and a corresponding recess (19).

7. High-current plug-and-socket connection system according to claim 3, wherein it is interlocked on the socket side and wherein for socket-side interlocking, at least one lock (4) that is directly coupled to the contactor drive (16) can be locked into a corresponding recess (17) of the guide projections (12) of the plug under the force of the magnetic field of the contactor coil (3).

8. High-current plug-and-socket connection system according to claim 6, wherein the plug-side and/or the socket-side interlock is assigned an unlocking mechanism (20).

9. High-current plug-and-socket connection system according to claim 1, wherein in the plug (2) and/or in the socket (1), there is a temperature-dependent resistor or a temperature-dependent semiconductor (26).

10. High-current plug-and-socket connection system according to claim 9, wherein in the plug (2) and/or in the socket (1), there is an evaluation electronic device that evaluates the temperature and shuts off power transmission if a given value is exceeded.

11. High-current plug-and-socket connection system according to claim 3, wherein auxiliary connections for an auxiliary voltage supply and/or for bus systems and/or for temperature monitoring and/or for identification of the plug (2) can be established via at least one guide projection (12) on the plug (2), the corresponding socket-side recess (13) and via contacts (21).

12. High-current plug-and-socket connection system according to claim 3, wherein at least one guide projection (12) of the plug (2) or the plug (2) has a transponder chip (23) that is evaluated via a receiver (24) that is mounted in the socket (1).

13. High-current plug-and-socket connection system according to claim 3, wherein it has a reset system (25) that is located in the socket-side recess (13), and when the plug (2) is plugged in, it can be moved by the guide projection (12) of the plug (2).

14. Modular charging station system for charging the batteries of electric vehicles, characterized by a base unit (31), a master module (32) and a user module (33), with the base unit (31) being configured without electronics and having at least one clamping device (34) for the power feed and compartments (35, 36) for accommodating the master module (32) and the user module (33).

15. Charging station system according to claim 14, wherein the base unit (31) has a flap (38) for releasing and closing plug-and-socket connections for the user module (33).

16. Charging station system according to claim 14, wherein it is parameterized by the master module (32).

17. Charging station system according to claim 14, wherein the master module (32) has an adjustable location identification (45).

18. Charging station system according to claim 14, wherein the master module (32) has an auxiliary voltage supply (43) for disconnection electronics, a system bus, a supply of a slave module or the like, or for electronic displays.

19. Charging station system according to claim 14, wherein the master module (32) has a switching relay (44) for disconnection of the charging voltage and for shutoff in a ground fault or overcurrent.

20. Charging station system according to claim 19, wherein the switching relay (44) is 2-pin or 4-pin.

21. Charging station system according to claim 19, wherein there is an interlocking mechanism that prevents the user module (33) from being pulled out with the relay (44) connected.

22. Charging station system according to claim 14, wherein the master module (32) has a power measurement and energy metering unit (46).

23. Charging station system according to claim 22, wherein on the user module (33), there is a measurement means and wherein the power measurement and energy metering unit (46) of the master module (32) monitors the measurement means of the user module (33).

24. Charging station system according to claim 14, wherein the master module (32) supplies the user module (33) with power via voltage supply lines (47) and wherein the master module (32) and the user module (33) communicate via system bus lines (48).

25. Charging station system according to claim 14, wherein the user module (33) has metering electronics (40) and a communications unit (42).

26. Charging station system according to claim 14, wherein the user module (33) in the position of use on its bottom has a flap (39) for release of a plug and wherein the flap (39) prevents unauthorized removal of a charging cable (37) by mechanical interlocking.

27. Charging station system according to claim 14, wherein the user module (33) has an energy storage device (49) that is charged via the master module (32) after the user module (33) is inserted into the base unit (31).

28. Charging station system according to claim 25, wherein the user module (33) has a protective electronic device (41) for ground fault monitoring that is active before the user module (33) is inserted into the base unit (31).

29. Charging station system according to claim 28, wherein the protective electronic device (41) displays errors, and the charging voltage is not enabled if there is an error.

30. Charging station system according to claim 25, wherein the communications unit (42) is a GSM unit with a SIM card compartment for communication via modem connection or SMS with a server center.

31. Charging station system according to claim 30, wherein an identification SMS can be received and evaluated via the communications unit (42) after inserting the user module (33) and after its interlocking, and current is enabled when a balance is covered.

32. Charging station system according to claim 30, wherein at the end of battery charging, the communications unit (42) sends an SMS to the vehicle owner with data (kWh, amount to be paid, charging time, etc.) and wherein the data can be stored in the communications unit (42).

33. Charging station system according to claim 25, wherein the user module (32) has a power measurement and energy metering means whose data are sent to a central server via the communications unit (42).

34. Charging station system according to claim 14, wherein it can be operated with a high-current transmission device.

35. Method for handling the charging of batteries of electric vehicles, wherein a first communications unit of a central computer is connected via a first data transmission means to at least one cell phone and to at least one adapter of a charging station and wherein battery charging is monitored and accounts are settled via the communications unit of the central computer.

36. Method according to claim 35, wherein the first communications unit of a central computer is the Internet.

37. Method according to claim 36, wherein the adapter of the charging station is connected to a second communications unit that is connected via a second data transmission means to at least one charging station means, and to a third communications unit that is connected via a third data transmission means to at least one electric vehicle.

38. Method according to claim 37, wherein the adapter for the charging station imports data from the charging station or from the electric vehicle via the second and/or third communications unit and outputs commands to the charging station or to the electric vehicle.

39. Method according to claim 37, wherein the charging station means is connected to a fourth communications unit that is connected to at least one other charging station means via a fourth data transmission means.

40. Method according to claim 39, wherein the adapter imports data about the charging station via the fourth communications unit and/or controls it.

41. Method according to claim 35, wherein after connecting an electric vehicle to the charging station in a first step via the first communications unit, a connection to the central computer is established, in a further step the data are checked, and in a positive check, battery recharging is enabled in another step.

42. Method according to claim 41, wherein after enabling battery charging, in a first step data about mechanical connections of charging station means and/or about the current flow and/or about a power measurement means on the adapter are checked and monitored by the central computer and/or the adapter via protective and monitoring electronics in the adapter, and the charging voltage for charging the electric vehicle is enabled in a further step in a positive check.

43. Method according to claim 35, wherein during charging of the electric vehicle, data about mechanical connections of the charging station means and/or about the current flow and/or about a power measurement means on the adapter are checked and monitored by the central computer and/or the adapter.

44. Method according to claim 35, wherein data about battery charging can be sent to the cell phone during charging of the electric vehicle.

45. Method according to claim 35, wherein current and/or historical data about battery charging are graphically displayed.

46. Method according to claim 35, wherein the data are stored in the central computer and/or in the adapter.

47. Method according to claim 46, wherein in a data interruption, the data that have not been transmitted to the central computer are buffered in the adapter, and in the next charging process, they are transmitted to the central computer.

48. Method according to claim 35, wherein during charging of the electric vehicle, switching processes are carried out, especially for manual or programmed remote control of the heating system.

49. Method according to claim 35, wherein as an adapter, a modular charging station system comprising a base unit (31), a master module (32) and a user module (33), with the base unit (31) being configured without electronics and having at least one clamping device (34) for the power feed and compartments (35, 36) for accommodating the master module (32) and the user module (33) is used.
